(19) United States
(12) Patent Application Publication
(10) Pub. No.: US 2004/0216952 A1
(43) Pub. Date: Nov. 4, 2004

(54) Modular tree ladder

(75) Inventor: Ronald R. Woller, Decatur, AL (US)

Correspondence Address: GARDNER GROFF, P.C., PAPER MILL VILLAGE, BUILDING 23, 600 VILLAGE TRACE, SUITE 300, MARIETTA, GA, 30067, US

(73) Assignee: Summit Treestands, LLC, Decatur, AL

(21) Appl. No.: 10/426,550

(22) Filed: Apr. 30, 2003

(51) Int. Cl. E06C 1/00

(52) U.S. Cl. 182/93; 182/100

(57) ABSTRACT

A modular ladder for mounting to a tree or pole includes a plurality of separate sections, each of which can be separately mounted to the tree or pole. Each of the separate tree mountable sections includes an upper step, a lower step, and a rigid frame element connecting the upper and lower steps. A flexible mounting element is used to secure the frame element to the tree or pole. Each of the steps projects radially outwardly from the tree when mounted, making it easier to use the steps in climbing the tree or pole. The steps each have a slot formed therein for permitting the nesting of the separate tree mountable sections one against another. In this way, the separate sections can be compactly configured for storage and carrying. Each of the steps is large enough to accommodate the user's two feet in side-by-side relationship. In this way, the user is not required to balance on only one foot while standing on the steps. The upper and lower steps are spaced apart by about two to three feet.

### FIELD OF THE INVENTION

The present invention relates generally to the field of climbing equipment, and more particularly to a modular ladder device for climbing trees and poles.

### BACKGROUND OF THE INVENTION

Hunters, photographers, naturalists, and other outdoorsmen have long realized the importance of obtaining an elevated vantage point to avoid detection by the intended animal subjects and to improve the outdoorsmen's view of those same animal subjects. When a semi-permanent platform is established for viewing wildlife, it is often desirable to use a ladder secured to the tree as a safe and effective device to climb to and descend from the platform.

One example of a known prior ladder device for such use is illustrated in U.S. Pat. No. 5,253,732, issued to Daniels. In the Daniels device, a hinged center post has a plurality of cantilevered rungs projecting alternately from opposite sides of the post so as to define staggered steps. Similarly, in U.S. Pat. No. 5,109,954, issued to Skyba, a pole ladder is shown to include three telescopically joined sections, each of which is provided with spaced apart rung assemblies formed from sheet metal. The rung assemblies provide opposed rungs shaped so as to be triangular when viewed from the front. U.S. Pat. No. 4,844,207, issued to Andrews et al., discloses another tree ladder that comprises several central pole sections, joined in end-to-end relationship.

U.S. Pat. No. 5,816,3620 Jenkins and U.S. Pat. No. 5,752,580 also to Jenkins describe a ladder system having a single vertical support member with a plurality of steps mounted thereto, wherein each step extends laterally from the vertical support member in a direction substantially tangential to the tree. A strap is provided for suspending the ladder from the tree.

U.S. Pat. No. 5,277,273 of Grimes relates to a climbing device for climbing a tree or pole. The Grimes patent discloses a climbing device having a pair of separate ladder-like sections that can be nested together. The individual ladder-like sections each include a pair of parallel vertical tubular frame pieces, with rungs or steps extending therebetween. The steps extend in a transverse direction away from the vertical posts and toward the tree when the sections are mounted to the tree. In this regard, the steps include a concave or rounded end for engaging the tree. This patent describes that each step is wide enough to accept a foot of a hunter wearing a boot. Thus, each of the steps is a single foot step, inconveniently requiring the user to balance on one foot in use.

These and other typical prior art arrangements generally suffer from several shortcomings. First of all, known prior art arrangements typically suffer from only allowing one foot of the user on a rung or step, and in many instances only a portion of the user's foot can be accommodated on the rung or step. This inability to place the entirety of both of the user's feet on a solid step or rung can make it difficult for the user to stand safely on the climbing device. Many known prior art devices also tend to be bulky, heavy, hard to use, or unsafe in some other manner.

Thus, it has been found that a need yet exists for an improved ladder for use in climbing trees and poles, which ladder is safe in use, convenient, lightweight, easy-to-use, and provides a stable, comfortable climbing aid. It is to the provision of such an improved ladder meeting these and other needs that the present invention is primarily directed.

### SUMMARY OF THE INVENTION

Briefly described, in a first preferred form the present invention comprises a modular ladder for mounting to a tree or pole. The modular ladder includes a plurality of separate sections, each of which can be separately mounted to the tree or pole. Each of the separate tree-mountable sections includes an upper step, a lower step, and a frame element connecting the upper and lower steps. A mounting strap or other flexible mounting element is used to secure the frame element to the tree or pole. The frame element is rigid and preferably comprises a post. Each of the steps projects radially outwardly from the tree when mounted, making it easier to use the steps in climbing the tree or pole.

Preferably, the steps each have a slot formed therein for permitting the nesting of the separate tree mountable sections one within the other. In this way, the separate sections can be compactly configured for storage and carrying. Also, preferably, the steps each include a V-shaped yoke portion for engaging the tree securely. It is also preferable that each of the steps is large enough to accommodate the user's two feet in side-by-side relationship. In this way, the user is not required to balance on only one foot while standing on the steps.

Preferably, the upper and lower steps are spaced apart by about 1½ to 3 feet. In one form of the invention, the upper and lower steps are spaced apart about 1½ feet (most preferably about 20 inches) from one another. In another form of the invention, the upper and lower steps are spaced apart from one another about 2 feet. In yet another form of the invention, the upper and lower steps are spaced apart from one another about 3 feet.

The present invention has numerous advantages, including increased safety. This is accomplished by several features. First of all, the ladder is securely mounted to the tree providing good support. Secondly, the steps extend radially outwardly from the tree, allowing the user's foot to get completely on the step without interference from the trunk of the tree or from the pole. This is in contrast to many prior art tree ladders comprising a horizontal rung which is spaced closely against or near the trunk of the tree. In such prior art arrangements, the user's foot is prevented from making full use of the rung by the near presence of the tree. The present invention overcomes this problem by extending the step radially outwardly away from the tree or pole, preventing the tree or pole from interfering with the user's foot. Also, the step is made large enough, preferably, to accommodate both of the user's feet at one time, providing a more stable and safer arrangement for the user.

Because of the compact configuration when nested, the modular tree letter is easily transported and carried. Also, because the modular tree letter is lightweight, it is also easy to carry. The lightweight nature of the device is in part due to the fact that the ladder is made of separate sections which are then spaced apart on the tree in use. In this way, frame weight can be minimized (some of the frame, which otherwise would extend between two separate sections can be eliminated, saving weight).

These and other features and advantages of preferred forms of the present invention are described herein with reference to the drawing figures.

### BRIEF DESCRIPTION OF THE DRAWING FIGURES

FIG. 1 is a perspective illustration of a multi-section modular tree ladder according to a first preferred form of the invention.

FIG. 2 is a perspective illustration of a first section portion of the modular tree ladder of FIG. 1.

FIG. 3 is a front view of the first section portion of the modular tree ladder of FIG. 2.

FIG. 4 is a plan view of the first section portion of the modular tree ladder of FIG. 2.

FIG. 5 is a perspective view of multiple sections of the modular tree ladder of FIG. 1 shown nested together for transport or storage.

### DETAILED DESCRIPTION OF THE PREFERRED EMBODIMENTS

Referring now to the drawing figures, in which like reference numbers refer to like parts throughout the several views, preferred forms of the present invention will now be described by way of example embodiments. It is to be understood that the embodiments described and depicted herein are only selected examples of the many and various forms that the present invention may take, and that these examples are not intended to be exhaustive or limiting of the claimed invention. Also, as used in the specification including the appended claims, the singular forms “a,” “an,” and “the” include the plural unless the context clearly dictates otherwise. Ranges may be expressed herein as from “about” or “approximately” one particular value and/or to “about” or “approximately” another particular value. When such a range is expressed, another embodiment includes from the one particular value and/or to the other particular value. Similarly, when values are expressed as approximations, by use of the antecedent “about,” it will be understood that the particular value forms another embodiment. Moreover, when describing the attachment of the ladder to a “tree” in the appended claims, it will be understood that this term “tree” encompasses poles as well as actual trees.

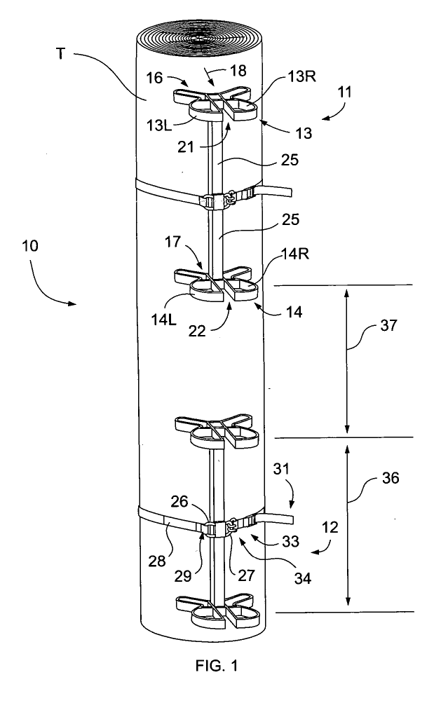

As shown in FIG. 1, the modular ladder 10 includes multiple sections, such as sections 11 and 12. While two such sections are shown in this figure, those skilled in the art will recognize that additional sections can be employed. Indeed, as contemplated in a unit to be sold commercially, the modular ladder would have three to six such sections, and preferably four sections. One noteworthy feature of this modular ladder construction is that the individual sections are designed in such a way that they do not need to be physically attached to one another. Instead, the sections are designed to be mounted on a tree or pole T spaced apart from one another vertically. As mentioned above, this has the advantage of saving on weight by completely eliminating the structure between some steps.

The upper section 11 includes an upper step 13 and a lower step 14. Each of the steps is roughly butterfly-shaped, including a tree engaging V-shaped yoke indicated generally at 16, 17. The steps are broad enough to accommodate both feet of a user standing thereon at one time. Each step includes a right foot portion,for example right foot portion 14R, and a left foot portion, for example left foot portion 14L. The steps extend radially outwardly in the direction of direction arrow 18 away from the center of the tree T when mounted to the tree or pole. This radial extension allows the user to get more of his foot on the step without obstruction from the tree itself. This makes the step safer and more comfortable to use.

Each step 13 and 14 includes a central slot formed therein, such as slots 21, 22. As will be seen in connection with a subsequent figure, the slots assist in the nesting of the sections one against another for compact transport or storage. A rigid post 25 extends between the upper step 13 and the lower step 14. The rigid post preferably comprises a piece of square tubing which is welded to the upper step and the lower step. In a preferred commercial embodiment, the upper and lower steps are made of extruded material and have a square opening formed therein for receiving the square tubing of the post 25. The post 25 is then welded to the step to secure it thereto. The extrusions, prior to being formed as steps, have the butterfly shape and are generally open. The extruded material is then cut to a certain length (here, the thickness of the step) to form the step. Preferably, the steps and the post are all made from aluminum or other lightweight material. As shown in the figures, preferably the steps have an open structure formed by upstanding sidewalls, thereby minimizing the weight of the step in comparison to a solid step.

The post includes a pair of rigid D-rings welded thereto, such as D-rings 26 and 27 of section 12. Attached to one of the D-rings (26) is a flexible strap 28. Preferably, this flexible strap 28 comprises a length of nylon webbing. Alternatively, other types of flexible mounting elements could be employed. Those skilled in the art will also recognize that a cable, chain, rope, belt or other flexible mounting element could be employed as desired. The flexible strap 28 includes a loop portion 29 which is looped through the D-ring 26 and permanently attached thereto by stitching. In other words, one end of the strap 28 is threaded through the D-ring 26 and then sewn onto itself to form a loop attachment. The opposite end 31 of the flexible strap 28 is threaded through a buckle mechanism 33. The buckle mechanism includes a pair of hook-shaped fingers 34 which slip into and engage with the other D-ring 27. As is conventionally known in the art, the buckle and flexible strap can be operated to cinch the flexible strap tightly against the tree or pole.

Still referring to FIG. 1, the spacing between the upper and lower steps, indicated at 36, preferably is about 1½ to 2 feet. Those skilled in the art will recognize that the 1½ foot spacing between the upper and lower steps makes it easier to climb from the first step to the next step, but requires a greater number of step sections to reach a given height in the tree or pole. Conversely, by spacing the steps farther apart, fewer separate step sections need to be carried in the field and mounted to the tree to achieve a particular height in the tree or pole, but at the expense of somewhat increasing the difficulty of climbing from one step to the next. It has been found that between about 1½ feet and 2 feet constitutes a very good compromise in this regard. Therefore, in a most preferred form, the step sections have a spacing of about 1½ to 2 feet. In the commercial embodiment, this spacing is set to be 20 inches. This figure also shows the use of multiple sections on a tree or pole, with one section being spaced apart from another section on the tree or pole. For example, as shown in FIG. 1, section 12 is placed upon the tree or pole and then another section, here section 11, is mounted to the tree or pole a selected distance 37 above section 12. The spacing 37 is completely up to the user in the field. However, typically the user would set the spacing to be roughly equal to the spacing between the upper and lower steps of each section. One nice advantage of this arrangement is that between the upper step of section 12 and lower step of section 11 there is no structure connecting these two separate sections, thereby eliminating the weight of such structure. This results in a substantial savings in weight in the structure that must be carried by the user in the field out to the tree or pole to reach a given height.

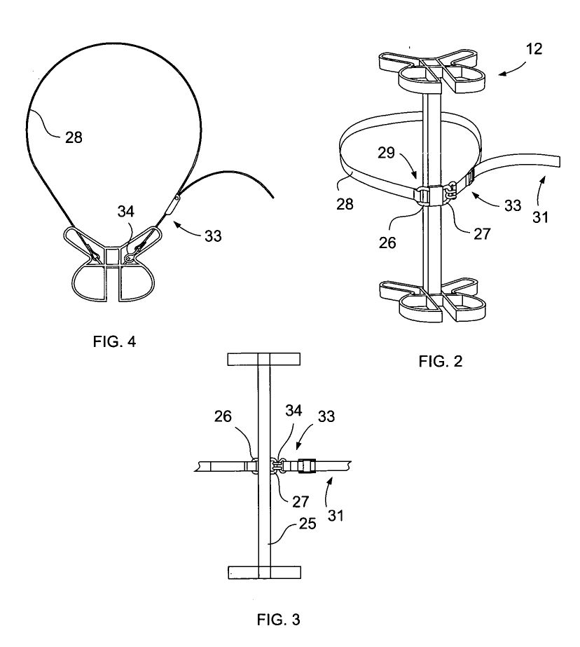

FIGS. 2-4 show an example of one of the separate sections in greater detail. In particular, FIGS. 2-4 show section 12 with greater clarity, in particular the buckle 33, the D-ring 27, the D-ring 26 and the loop end 29 of the flexible strap 28.

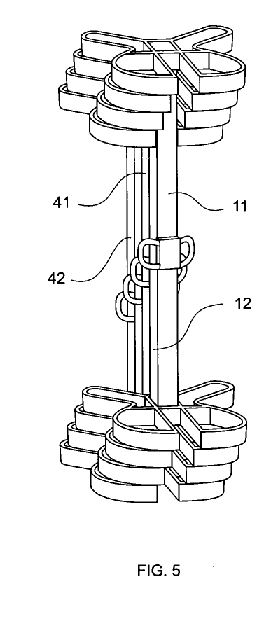

FIG. 5 shows four separate sections, 11, 12, 41, and 42 stacked together in a compact, nested arrangement. This compact nested arrangement is particularly suitable for storage or transport of the sections. This compact, nesting arrangement also is convenient for merchandising the product in a retail store in a minimum of space. The nesting is accomplished by virtue the fact that the slots formed in the steps are wide enough to accommodate the post extending between the steps. Ideally, the width of the slots is just slightly greater than that of the post so that the post are snugly received within the slots of an adjacent section, while still allowing that the separate sections can be pulled apart from one another. To help hold the sections together in this nested arrangement, one of the mounting straps can be attached to one of the D-rings of one of the outermost sections then wrapped around all four posts and cinched tight.

While the invention has been described in its preferred forms, it will be readily apparent to those of ordinary skill in the art that many additions, modifications and deletions can be made thereto without departing from the spirit and scope of the invention as set forth in the following claims.

1. A modular ladder for mounting to a tree or pole, comprising:
a plurality of separate sections adapted to be mounted to the tree or poles each of the plurality of separate sections including a first step, a second step, a frame extending between the first and second steps and spacing the first and second steps apart from one another, and a flexible mounting element for securing the frame to the tree or pole, and wherein the steps project radially outwardly from the tree or pole when mounted thereto.

2. A modular ladder as claimed in claim 1 wherein the flexible mounting element comprises a strap, belt, cable, chain, or rope.

3. A modular ladder as claimed in claim 1 wherein the steps each have a slot formed therein to permit the nesting of the sections for storage and transport.

4. A modular ladder as claimed in claim 1 wherein the steps are each large enough to accommodate two feet situated thereon.

5. A modular ladder as claimed in claim 1 wherein the frame element comprises a rigid post.

6. A modular ladder as claimed in claim 1 wherein the steps are spaced apart about 1½ to 3 feet.

7. A modular ladder as claimed in claim 1 wherein the first step and the second step are spaced apart from one another about 1½ feet.

8. A modular ladder as claimed in claim 1 wherein the first step and the second step are spaced apart from one another about 2 feet.

9. A modular ladder as claimed in claim 1 wherein the first step and second step are spaced apart from one another about 2½ feet.

10. A modular ladder as claimed in claim 1 wherein the steps are spaced apart about 20 inches.

11. A modular ladder as claimed in claim 2 wherein the frame includes at least one loop securely mounted thereto for attaching the flexible mounting element.

12. A modular ladder for mounting to a tree or pole comprising:
a plurality of separate sections adapted to be mounted to the tree or pole, each of the plurality of sections including a first step, a second step, a frame extending between the first and second steps and spacing the first and second steps apart from one another, and a flexible mounting element for securing the frame to the tree or pole, and wherein the steps each have a slot permitting the nesting of the sections for storage and transport.

13. A modular ladder as claimed in claim 12 wherein the steps project radially outwardly from the tree or pole when mounted thereto.

14. A modular ladder as claimed in claim 12 wherewith steps are each large enough to accommodate two feet when placed thereon.

15. A modular ladder as claimed in claim 12 when the first and second steps are spaced apart from one another about 1½ feet.

16. A modular ladder as claimed in claim 12 wherein the first and second steps are spaced apart from one another about 2 feet.

17. A modular ladder as claimed in claim 12 wherein the first and second steps are spaced apart from one another about 2½ feet.

18. A modular ladder as claimed in claim 12 wherein the flexible mounting element comprises a strap, belt, cable, chain, or rope.

19. A modular ladder as claimed in claim 12 wherein the steps are spaced apart about 20 inches.
